(19) United States
(12) Patent Application Publication
(10) Pub. No.: US 2026/0269552 A1
(43) Pub. Date: Sep. 10, 2026

(54) HYBRID PUMPED SLAB LASER AMPLIFIER

(71) Applicant: Xiamen Unit Electronic and Technology Company Ltd., Xiamen (CN)

(72) Inventors: WENJUN LIU, Xiamen (CN); QI LIU, Xiamen (CN); KUI LI, Xiamen (CN); LISONG WEN, Xiamen (CN); ZHENLI YANG, Xiamen (CN)

(21) Appl. No.: 19/073,312

(22) Filed: Mar. 7, 2025

(51) Int. Cl. H01S 3/02; H01S 3/06

(52) U.S. Cl. CPC H01S 3/025; H01S 3/0606

(57) ABSTRACT

A hybrid pumped slab laser amplifier is provided, which includes a laser amplifier body, a front surface of the laser amplifier body is provided with a support mechanism, the support mechanism includes an annular support frame, an upper surface of the annular support frame is fixedly connected with an arc-shaped rod, a lower surface of the annular support frame is fixedly connected with a sliding rod, a lower surface of the sliding rod penetrates through a chassis and is slidably connected with the chassis, a lower surface of the chassis is fixedly connected with a base, an outer arc surface of the sliding rod is sleeved with a first spring, and this hybrid pumped slab laser amplifier can be protected by the annular support frame, the sliding rod, the first spring, a sliding block and a second spring.

### TECHNICAL FIELD

The present disclosure relates to the field of laser application technologies, and in particular, to a hybrid pumped slab laser amplifier.

### BACKGROUND

In many practical applications, high-quality laser beams, namely single transverse mode and single longitudinal mode laser beams, are required. However, lasers operating in single-mode conditions do not have high power or energy output due to high cavity losses and small mode volume. In order to increase power or energy, it is necessary to use a laser amplifier.

Since most of the laser amplifiers are exposed, after a long time of use, the surface of the laser amplifiers is dusty, which is easy to affect the use of the laser amplifiers during daily use and storage. At the same time, there is a lack of protection mechanism, so it is easy to cause bumps. Therefore, a hybrid pumped slab laser amplifier is proposed to solve the above problems.

### SUMMARY

In view of shortcomings of the prior art, the present disclosure provides a hybrid pumped slab laser amplifier, which solves problems that the surface of the laser amplifier is too dusty to be cleaned after a long time of use, and a lack of a protective mechanism is easy to cause bumps.

To achieve the above purpose, the present disclosure provides the following technical scheme: a hybrid pumped slab laser amplifier, including a laser amplifier body, where a front surface of the laser amplifier body is provided with a support mechanism, the support mechanism includes an annular support frame, an inner surface of the annular support frame is fixedly connected with the laser amplifier body, an upper surface of the annular support frame is fixedly connected with an arc-shaped rod, a lower surface of the annular support frame is fixedly connected with a sliding rod, a lower surface of the sliding rod penetrates through a chassis and is slidably connected with the chassis; a lower surface of the chassis is fixedly connected with a base, and an outer arc surface of the sliding rod is sleeved with a first spring.

In some embodiments of the present disclosure, a front surface of the chassis is slidably connected with a sliding block, the sliding block is hinged with one end of a bracket, and the sliding rod is further hinged with the other end of the bracket, the sliding block is fixedly connected with one end of a second spring, and the chassis is fixedly connected with the other end of the second spring.

In some embodiments of the present disclosure, an outer arc surface of the annular support frame is fixedly connected with frames, and the frames are symmetrically arranged with a center line of the laser amplifier body as a symmetrical axis.

In some embodiments of the present disclosure, an adjusting mechanism is provided on an upper surface of the base, the adjusting mechanism includes a motor, an output shaft of the motor runs through the chassis and is slidably connected with the chassis, the output shaft of the motor is slidably connected with a gear, an upper surface of the chassis is fixedly connected with an inner ring, and the inner ring is meshed with the gear.

In some embodiments of the present disclosure, an upper surface of the output shaft of the motor penetrates through a movable rod and is slidably connected with the movable rod, an upper surface of the movable rod is fixedly connected with a connection plate, and a lower surface of the connection plate is fixedly connected with the gear.

In some embodiments of the present disclosure, a front surface of the connection plate penetrates through a conical rod and is slidably connected with the conical rod, the conical rod is fixedly connected with one end of a third spring, the connection plate is fixedly connected with the other end of the third spring, the output shaft of the motor is provided with a conical groove, and the conical groove is in the same horizontal plane with the conical rod, and an inner surface of the conical groove is slidably connected with the conical rod.

In some embodiments of the present disclosure, the upper surface of the chassis is fixedly connected with a trapezoidal plate, and a lower surface of the trapezoidal plate is slidably connected with the gear.

In some embodiments of the present disclosure, the outer arc surface of the annular support frame is provided with a dust removal mechanism, the dust removal mechanism includes a rotating shaft, an outer arc surface of the rotating shaft is fixedly connected with fan blades, a front surface of the rotating shaft is fixedly connected with a rotating plate, the outer arc surface of the annular support frame is provided with recesses that are arranged in a c ircumferential array, and inner surfaces of the recesses are rotationally connected with the rotating shaft.

In some embodiments of the present disclosure, the upper surface of the base is fixedly connected with a baffle, an upper surface of the baffle is slidably connected with an outer arc surface of the rotating plate.

Compared with the prior art, the present disclosure provides a hybrid pumped slab laser amplifier, which has the following beneficial effects.
1. This hybrid pumped slab laser amplifier can protect the laser amplifier by the annular support frame, sliding rod, first spring, sliding block and second spring, which can effectively protect the laser amplifier from impact and improve the service life of the laser amplifier.
2. This hybrid pumped slab laser amplifier can adjust the angle of the laser amplifier by providing the motor, gear, inner ring and connection plate, and can shake and rotate up and down at the same time, which is convenient for cleaning the dust on the surface of the laser amplifier.
3. This hybrid pumped slab laser amplifier uses the setting of rotating shaft, rotating plate and baffle. After the laser amplifier rotates through the motor and annular support frame, the rotating shaft drives the fan to rotate, blowing the dust off the surface of the laser amplifier, which is convenient for cleaning the laser amplifier.

### BRIEF DESCRIPTION OF DRAWINGS

FIG. 1 is an overall structure diagram of a hybrid pumped slab laser amplifier proposed by the present disclosure.

FIG. 2 is an overall structure diagram of a support mechanism of the hybrid pumped slab laser amplifier proposed by the present disclosure.

FIG. 3 is an overall structure diagram of an adjusting mechanism of the hybrid pumped slab laser amplifier proposed by the present disclosure.

FIG. 4 is an enlarged schematic diagram of part A in FIG. 3 of the hybrid pumped slab laser amplifier proposed by the present disclosure.

FIG. 5 is an overall structure diagram of an output shaft of a motor of the hybrid pumped slab laser amplifier proposed by the present disclosure.

FIG. 6 is an overall structure diagram of a dust removal mechanism of the hybrid pumped slab laser amplifier proposed by the present disclosure.

FIG. 7 is an enlarged schematic diagram of part B in FIG. 6 of the hybrid pumped slab laser amplifier proposed by the present disclosure.

### NUMERAL REFERENCE

1—laser amplifier body; 2—support mechanism; 21—annular support frame; 22—arc—shaped rod; 23—sliding rod; 24—chassis; 25—base; 26—first spring; 27—sliding block; 28—bracket; 29—second spring; 210—frame; 3—adjusting mechanism; 31—motor; 32—gear; 33—inner ring; 34—movable rod; 35—connection plate; 36—conical rod; 37—third spring; 38—conical groove; 39—trapezoidal plate; 4—dust removal mechanism; 41—rotating shaft; 42—rotating plate; 43—recess; 44—baffle.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

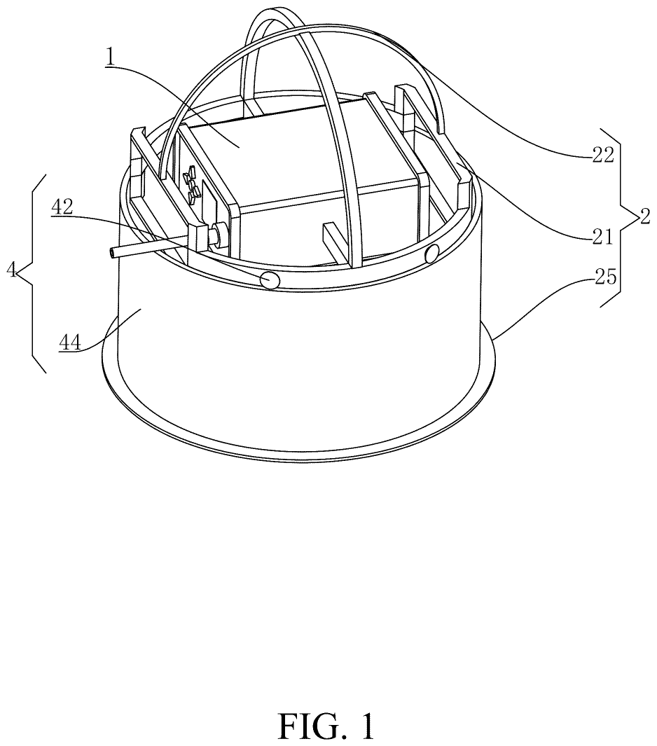

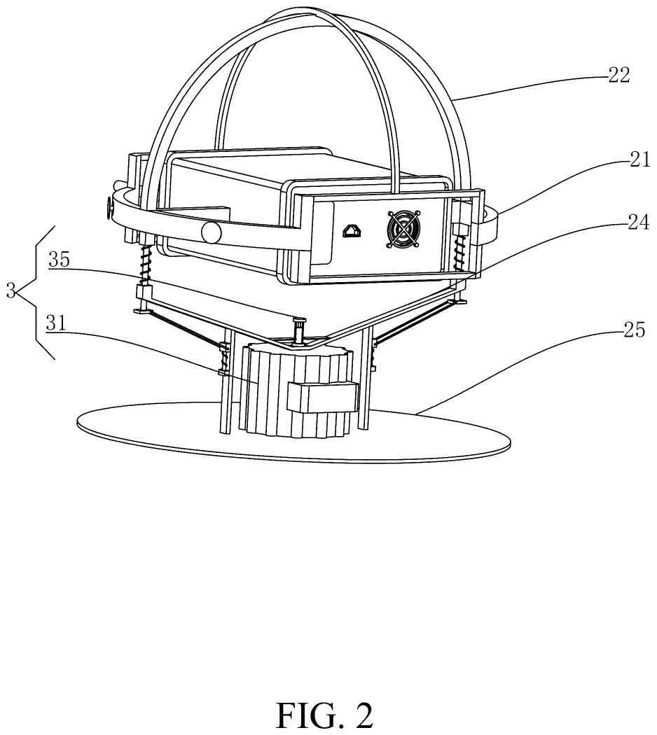

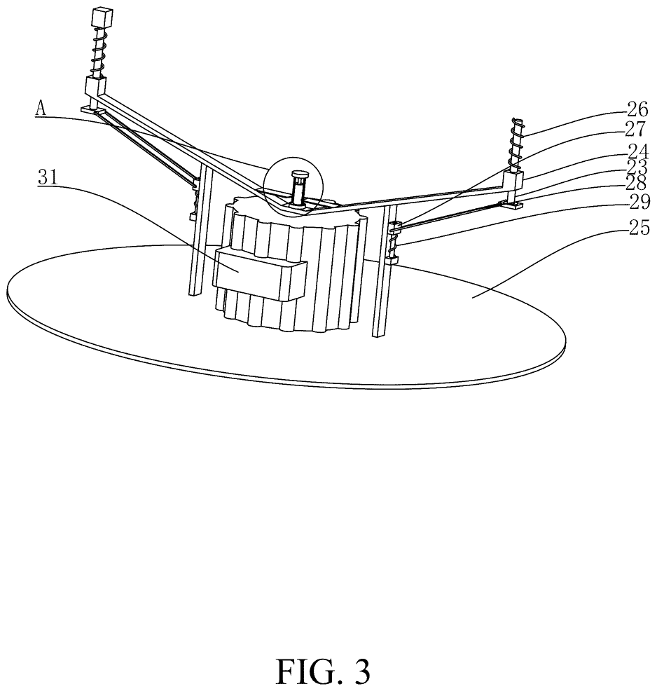

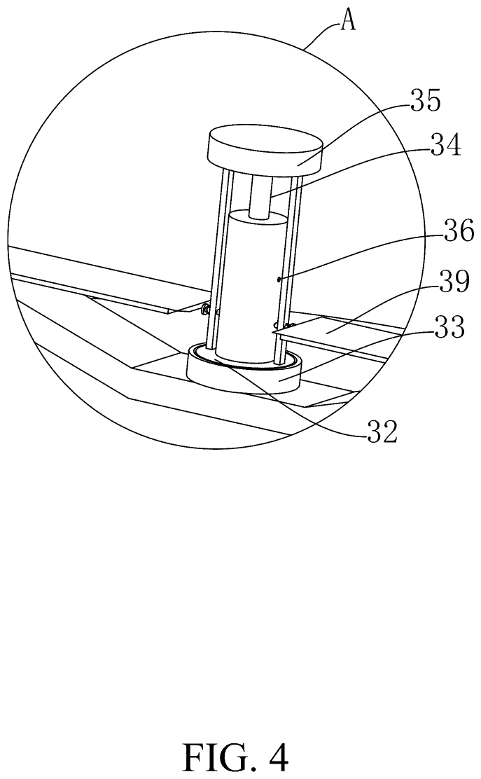

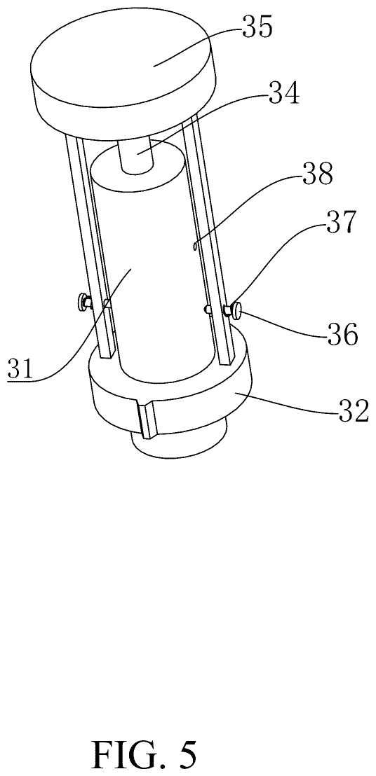

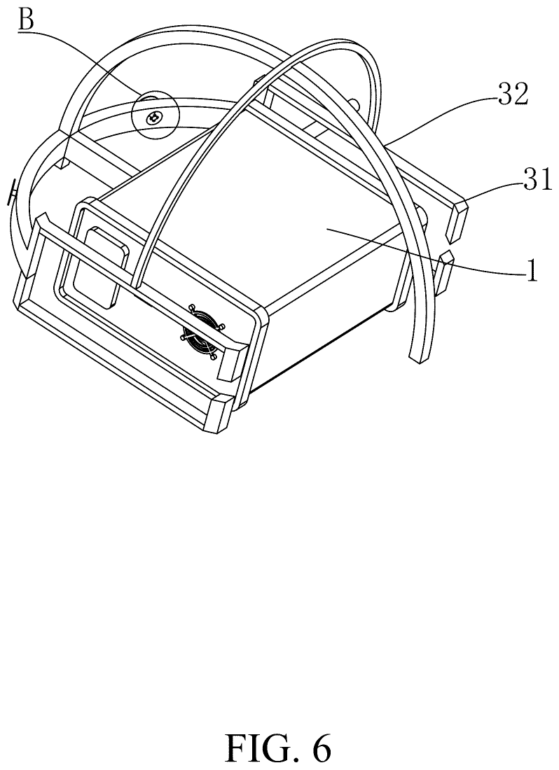

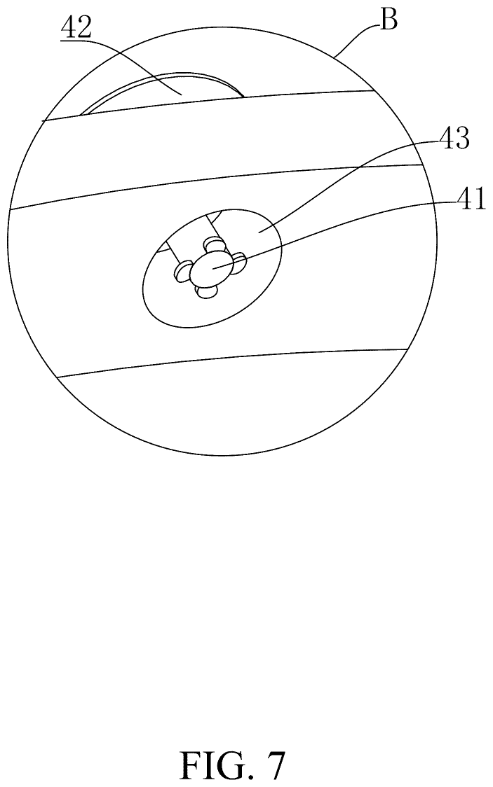

Refer to FIGS. 1-7, a hybrid pumped slab laser amplifier, including a laser amplifier body 1, a front surface of the laser amplifier body 1 is provided with a support mechanism 2, the support mechanism 2 includes an annular support frame 21, an inner surface of the annular support frame 21 is fixedly connected with the laser amplifier body 1, an upper surface of the annular support frame 21 is fixedly connected with an arc-shaped rod 22, a lower surface of the annular support frame 21 is fixedly connected with a sliding rod 23, a lower surface of the sliding rod 23 is penetrated through a chassis 24 and is slidably connected with the chassis 24, a lower surface of the chassis 24 is fixedly connected with a base 25, an outer arc surface of the sliding rod 23 is sleeved with a first spring 26, and a front surface of the chassis 24 is slidably connected with a sliding block 27. The sliding block 27 is hinged with one end of a bracket 28, and the sliding rod 23 is further hinged with the other end of the bracket 28; the sliding block 27 is fixedly connected with one end of a second spring 29, and the chassis 24 is fixedly connected with the other end of the second spring 29; an outer arc surface of the annular support frame 21 is fixedly connected to frames 210, which have the same length and width as the laser amplifier body 1. Through this setting, it is convenient to operate the laser amplifier body 1. The frames 210 are symmetrically arranged with a centerline of the laser amplifier body 1 as a symmetrical axis. By setting two sets of frames 210, the operation of the laser amplifier body 1 is more convenient without affecting the protection effect of the laser amplifier body 1. By providing the annular support frame 21, the sliding rod 23, the first spring 26, the sliding block 27, and the second spring 29, the laser amplifier can be protected, thereby effectively protecting it from collision and improving its service life. An upper surface of the base 25 is provided with an adjusting mechanism 3, which includes a motor 31, an output shaft of the motor 31 runs through the chassis 24 and is slidably connected to the chassis 24. The output shaft of the motor 31 is slidably connected to a gear 32, and an upper surface of chassis 24 is fixedly connected to an inner ring 33 that meshes with the gear 32. A front surface of connection plate 35 runs through a conical rod 36 and is slidably connected to the conical rod 36. An upper surface of the output shaft of the motor 31 runs through a movable rod 34 and is slidably connected to the movable rod 34. An upper surface of the movable rod 34 is fixedly connected to the connection plate 35, and a lower surface of the connection plate 35 is fixedly connected to the gear 32. The conical rod 36 is fixedly connected to one end of a third spring 37, and the connection plate 35 is fixedly connected to the other end of the third spring 37. The output shaft of the motor 31 is provided with a conical groove 38, and the conical groove 38 is in the same horizontal plane with the conical rod 36, and through a mutual cooperation between the conical groove 38 and the conical rod 36, after the conical rod 36 and the conical groove 38 cooperate with each other, by an elastic force of the third spring 37, the conical rod 36 can be bounced into the conical groove 38, thereby limiting an upward movement of the gear 32. An inner surface of the conical groove 38 is slidably connected to the conical rod 36. An upper surface of the chassis 24 is fixedly connected to a trapezoidal plate 39, and a lower surface of the trapezoidal plate 39 is slidably connected to the gear 32. The gear 32 is set as a single tooth bud. After the gear 32 is rotated, it will compress an inclined surface of the lower surface of the trapezoidal plate 39, thereby driving the chassis 24 to move upward, compressing the first spring 26 and the second spring 29, therefore achieving an up-and-down movement of the chassis 24 and shaking the laser amplifier body 1 to shake off dust. By providing the motor 31, the gear 32, the inner ring 33, and the connection plate 35, it is possible to adjust the angle of the laser amplifier while allowing for up and down shaking and rotation, facilitating the cleaning of dust on the surface of the laser amplifier. The outer arc surface of the annular support frame 21 is provided with a dust removal mechanism 4, which includes a rotating shaft 41. An outer arc surface of the rotating shaft 41 is fixedly connected to fan blades, and a front surface of the rotating shaft 41 is fixedly connected to a rotating plate 42. The outer arc surface of the annular support frame 21 is provided with recesses 43 that are arranged in a circular array, and inner surfaces of the recesses 43 are rotatably connected to the rotating shaft 41. Through the providing of the recesses 43, the rotating shaft 41 can be clamped in the recesses 43, so that the rotating shaft 41 can rotate stably. The upper surface of the base 25 is fixedly connected to a baffle 44, and an upper surface of the baffle 44 is slidably connected to an outer arc surface of the rotating plate 42. By the providing of the rotating shaft 41, the rotating plate 42, and the baffle 44, the laser amplifier is driven to rotate by the motor 31 and the annular support frame 21, after the fan is driven by the rotating shaft 41 to blow off the dust on the surface of the laser amplifier, it is easy to clean the laser amplifier.

Working principle: when it is necessary to clean the dust on the surface of the laser amplifier body 1, the connection plate 35 is pulled upwards, and the connection plate 35 drives the gear 32 to move upwards. When the connection plate 35 drives the conical rod 36 to be parallel to the conical groove 38, the conical rod 36 is pushed into the conical groove 38 by the elastic force of the third spring 37, therefore limiting the gear 32. After the gear 32 is moved to the lower surface of the trapezoidal plate 39, the motor 31 is started. The motor 31 drives the gear 32 to rotate, and tooth buds of the gear 32 will press the inclined surface of the lower surface of the trapezoidal plate 39, the trapezoidal plate 39 is caused to drive the chassis 24 to move upwards. At the same time, the first spring 26 and the second spring 29 are compressed. When the tooth buds of the gear 32 do not abut against the lower inclined surface of the trapezoidal plate 39, the spring force of the first spring 26 and the second spring 29 restores an original position, allowing the chassis 24 to shake up and down. After shaking the dust, the connection plate 35 is pressed down, the connection plate 35 drives the conical rod 36 to move downwards. At the same time, the inner surface of the conical groove 38 will compress the curved surface of the conical rod 36, and the conical rod 36 is caused to move outward, while compressing the third spring 37. When the gear 32 enters the inner ring 33 and meshes with the inner ring 33, the motor 31 is started again, and cooperates with the inner ring 33 to drive the annular support frame 21 to rotate. When the annular support frame 21 drives the rotating shaft 41 and the rotating plate 42 to rotate, the outer arc surface of the rotating plate 42 will rub against the baffle 44, thereby driving the rotating shaft 41 to rotate. After the rotating shaft 41 drives the fan to rotate, the dust on the upper surface of the laser amplifier body 1 is blown off, thereby achieving the dust cleaning function.

When the laser amplifier body 1 is placed normally, the arc-shaped rod 22 can effectively protect the laser amplifier body 1. After the arc-shaped rod 22 is compressed, it will drive the annular support frame 21 to move downwards, and the annular support frame 21 will drive the sliding rod 23 to move downwards. At this time, the sliding rod 23 is connected to the sliding block 27 through a bracket 28, and the sliding block 27 will move downwards. At the same time, the first spring 26 and the second spring 29 are compressed. With this elastic force, the laser amplifier body 1 can have a certain buffering effect after being bumped.

It should be noted that in this specification, relational terms such as first and second are only used to distinguish one entity or operation from another, and do not necessarily require or imply any actual relationship or order between these entities or operations. Furthermore, the terms “including”, “comprising”, or any other variation thereof are intended to cover a non-exclusive inclusion. This means that a process, method, item, or device comprising a series of elements includes not only those elements but also other elements not explicitly listed or elements inherent to such process, method, item, or device. Without further limitations, the element defined by the statement “including one . . . ” does not exclude the existence of other identical elements in the process, method, item, or device that includes the element in question.

What is claimed is:

1. A hybrid pumped slab laser amplifier, comprising a laser amplifier body, wherein a front surface of the laser amplifier body is provided with a support mechanism, the support mechanism comprises an annular support frame, an inner surface of the annular support frame is fixedly connected with the laser amplifier body,
an upper surface of the annular support frame is fixedly connected with an arc-shaped rod, a lower surface of the annular support frame is fixedly connected with a sliding rod, a lower surface of the sliding rod penetrates through a chassis and is slidably connected with the chassis;
a lower surface of the chassis is fixedly connected with a base, and an outer arc surface of the sliding rod is sleeved with a first spring.

2. The hybrid pumped slab laser amplifier according to claim 1, wherein a front surface of the chassis is slidably connected with a sliding block, the sliding block is hinged with one end of a bracket, and the sliding rod is further hinged with the other end of the bracket,
the sliding block is fixedly connected with one end of a second spring, and the chassis is fixedly connected with the other end of the second spring.

3. The hybrid pumped slab laser amplifier according to claim 2, wherein an outer arc surface of the annular support frame is fixedly connected with frames, and the frames are symmetrically arranged with a center line of the laser amplifier body as a symmetrical axis.

4. The hybrid pumped slab laser amplifier according to claim 3, wherein an adjusting mechanism is provided on an upper surface of the base, the adjusting mechanism comprises a motor, an output shaft of the motor runs through the chassis and is slidably connected with the chassis,
the output shaft of the motor is slidably connected with a gear, an upper surface of the chassis is fixedly connected with an inner ring, and the inner ring is meshed with the gear.

5. The hybrid pumped slab laser amplifier according to claim 4, wherein an upper surface of the output shaft of the motor penetrates through a movable rod and is slidably connected with the movable rod,
an upper surface of the movable rod is fixedly connected with a connection plate, and a lower surface of the connection plate is fixedly connected with the gear.

6. The hybrid pumped slab laser amplifier according to claim 5, wherein a front surface of the connection plate penetrates through a conical rod and is slidably connected with the conical rod,
the conical rod is fixedly connected with one end of a third spring,
the connection plate is fixedly connected with the other end of the third spring,
the output shaft of the motor is provided with a conical groove, and the conical groove is in the same horizontal plane with the conical rod, and an inner surface of the conical groove is slidably connected with the conical rod.

7. The hybrid pumped slab laser amplifier according to claim 6, wherein the upper surface of the chassis is fixedly connected with a trapezoidal plate, and a lower surface of the trapezoidal plate is slidably connected with the gear.

8. The hybrid pumped slab laser amplifier according to claim 7, wherein the outer arc surface of the annular support frame is provided with a dust removal mechanism, the dust removal mechanism comprises a rotating shaft, an outer arc surface of the rotating shaft is fixedly connected with fan blades, a front surface of the rotating shaft is fixedly connected with a rotating plate, the outer arc surface of the annular support frame is provided with recesses that are arranged in a circumferential array, and inner surfaces of the recesses are rotationally connected with the rotating shaft.

9. The hybrid pumped slab laser amplifier according to claim 8, wherein the upper surface of the base is fixedly connected with a baffle, an upper surface of the baffle is slidably connected with an outer arc surface of the rotating plate.
